(19) United States
(12) Patent Application Publication
(10) Pub. No.: US 2007/0024783 A1
(43) Pub. Date: Feb. 1, 2007

(54) Liquid crystal display and method for making the same

(76) Inventor: Young-Kuil Joo, Cheonan-si (KR)

Correspondence Address: CANTOR COLBURN, LLP, 55 GRIFFIN ROAD SOUTH, BLOOMFIELD, CT, 06002, US

(21) Appl. No.: 11/494,856

(22) Filed: Jul. 28, 2006

(30) Foreign Application Priority Data
Jul. 28, 2005 (KR) 10-2005-0068762

(51) Int. Cl. G02F 1/1337

(52) U.S. Cl. 349/123

(57) ABSTRACT

A liquid crystal display includes, a first panel, a second panel facing the first panel, a pair of electric-field generating electrodes formed on at least one of the first panel and the second panel, an alignment layer formed on at least one of the electric-field generating electrodes and having an average roughness equal to or less than about 8 nm, and a liquid crystal layer disposed between the first panel and the second panel and comprising liquid crystal molecules having a tilt angle equal to or greater than about five degrees relative to a surface of the alignment layer.

This Application claims priority to Korean Patent Application No. 10-2005-0068762 filed on Jul. 28, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a liquid crystal display (“LCD”) and method thereof. More particularly, the present invention relates to an LCD with reduced linear afterimage and a method for making the same.

(b) Description of Related Art

An LCD is one of the most widely used flat panel displays. An LCD includes two panels provided with field-generating electrodes, such as pixel electrodes and a common electrode, and a liquid crystal (“LC”) layer interposed therebetween. The LCD displays images by applying voltages to the field-generating electrodes to generate an electric field in the LC layer, which determines an orientation of the LC molecules in the LC layer to adjust polarization of incident light.

The panels of the LCD further include a plurality of thin film transistors (“TFTs”) for selectively transmitting data signals to the pixel electrodes and a plurality of signal lines for transmitting electrical signals to the TFTs. The signal lines include gate lines transmitting gate signals for controlling the TFTs and data lines transmitting data signals.

The panels of the LCD further include respective alignment layers for aligning the LC molecules and a sealant for enclosing the liquid crystal layer.

Unfortunately, the liquid crystal layer also contains ion impurities as well as the LC molecules. The ion impurities come from the LC molecules, the thin films or the sealant. Examples of the ion impurities include alkaline metals such as Na, K, Cs, etc., sulfur compounds and chlorine compounds.

The ion impurities move laterally along an electric field generated in the LC layer and gather in a small number of places, in particular, near the boundaries of the pixel electrodes. The ion impurities reduce the voltage holding ratio (“VHR”), which is defined as a ratio of the voltage difference between a pixel electrode and a common electrode after a TFT turns off relative to the initial voltage difference, thereby causing a linear afterimage.

### BRIEF SUMMARY OF THE INVENTION

The present invention provides a display and method for making the same that reduces linear afterimage effects.

An exemplary embodiment of the present invention provides a liquid crystal display including a first panel, a second panel facing the first panel, a pair of electric-field generating electrodes formed on at least one of the first panel and the second panel, an alignment layer formed on at least one of the electric-field generating electrodes and having an average roughness equal to or less than about 8 nm, and a liquid crystal layer disposed between the first panel and the second panel and comprising liquid crystal molecules having a tilt angle substantially equal to or greater than about five degrees relative to a surface of the alignment layer.

According to an exemplary embodiment, the tilt angle of the liquid crystal molecules may be equal to or lower than about ten degrees.

According to an exemplary embodiment, the alignment layer may have a surface energy equal to or greater than about 50 dyn/cm, and preferably equal to or less than about 60 dyn/cm.

According to an exemplary embodiment, the alignment layer may include polymers, and each polymer may include a main chain and a side chain. The main chain may extend along a surface of the first panel and the side chain may be coupled to an intermediate position of the main chain and may include a structure controlling the tilt of the liquid crystal molecules. The structure controlling the tilt of the liquid crystal molecules may include an aromatic group of polymers. The alignment layer may be rubbed, and the tilt angle of the liquid crystal molecules is substantially equal to the angle that the side chain stands at due to the rubbing. The alignment layer may further include a crosslinking agent combining the main chains of the polymers.

According to an exemplary embodiment, the alignment layer comprises polyimide compounds.

According to an exemplary embodiment, the liquid crystal display may further include a color filter disposed adjacent at least one of the electric-field generating electrodes and having an average roughness equal to or less than about eight nanometers.

According to an exemplary embodiment, the liquid crystal display may further include a gate line disposed on one of the first panel and the second panel, a data line intersecting the gate line, and a thin film transistor electrically coupled to the gate line, the data line, and the electric-field generating electrode.

An exemplary embodiment of the present invention also provides a method of making a liquid crystal display. The method comprises: forming a first panel; forming a second panel; forming a first electric-field generating electrode on at least one of the first panel and the second panel; forming a second electric-field generating electrode on at least one of the first panel and the second panel; forming an alignment layer on at least one of the first electric-field generating electrode and the second electric-field generating electrode and having an average roughness equal to or less than about 8 nanometers; and forming a liquid crystal layer disposed between the first panel and the second panel and comprising liquid crystal molecules having a tilt angle equal to or greater than about five degrees relative to a surface of the alignment layer.

### BRIEF DESCRIPTION OF THE DRAWINGS

The present invention will become more apparent by describing exemplary embodiments thereof in detail with reference to the accompanying drawings in which:

FIG. 1 is a top plan view layout of an exemplary embodiment of a TFT array panel according to the present invention;

FIG. 2 is a cross-sectional view of the TFT array panel shown in FIG. 1 taken along line II-II;

FIG. 3 is a cross-sectional view of the TFT array panel shown in FIG. 1 taken along line III-III;

FIG. 4A is a perspective schematic view of an exemplary embodiment of a liquid crystal panel and an alignment layer disposed thereon according to the present invention;

FIG. 4B is a graph showing the relation between the surface energy and the adsorption of the ion impurities;

FIG. 5 is a graph showing an occurrence of a linear afterimage according to the pretilt angle;

FIGS. 6 and 7 are schematic diagrams showing structures of exemplary embodiments of an alignment layer according to the present invention; and

FIG. 8 is a graph showing the pretilt angle as a function of UV exposure time.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

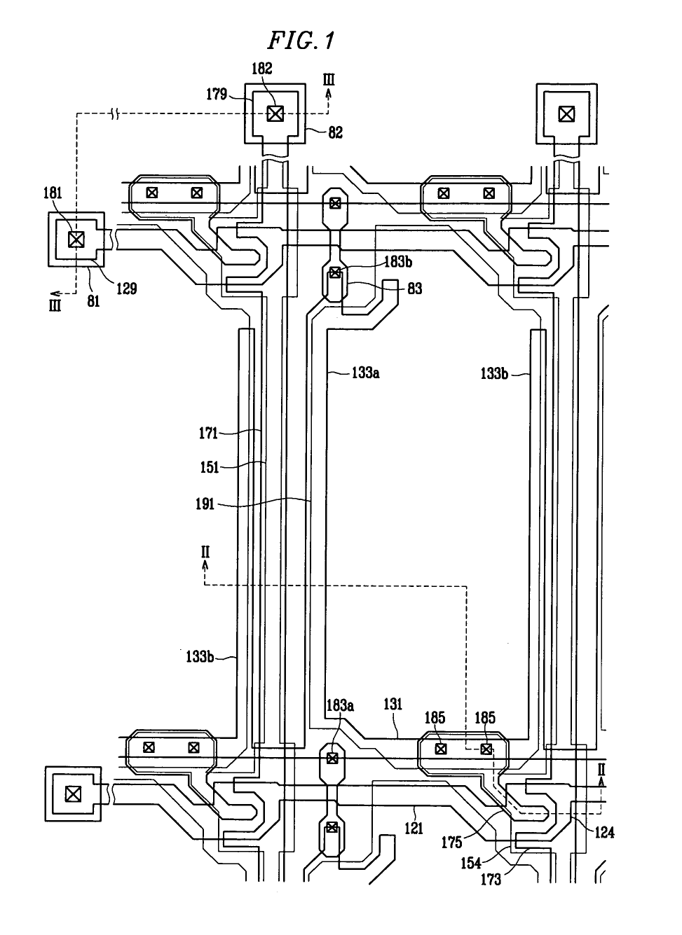

A liquid crystal display according to an exemplary embodiment of the present invention will be described with reference to FIGS. 1, 2 and 3.

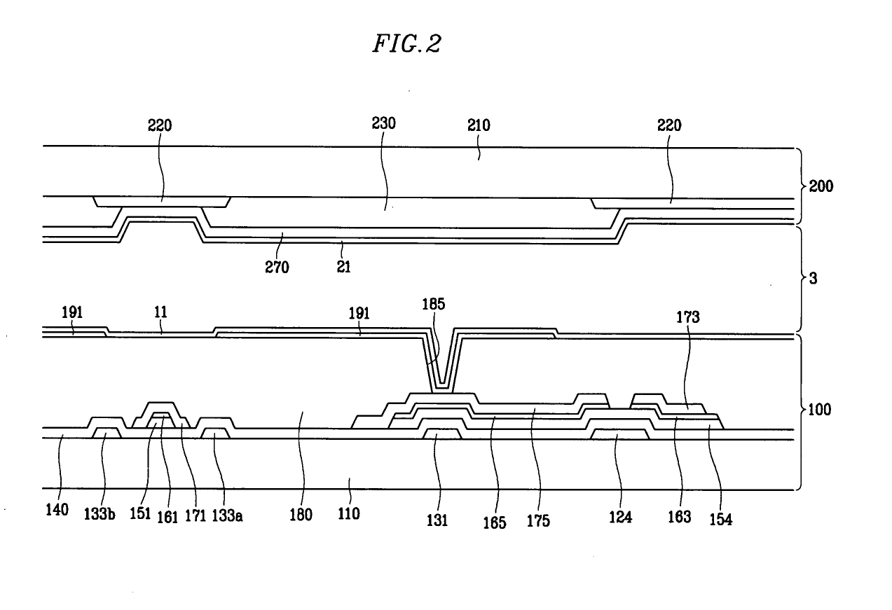

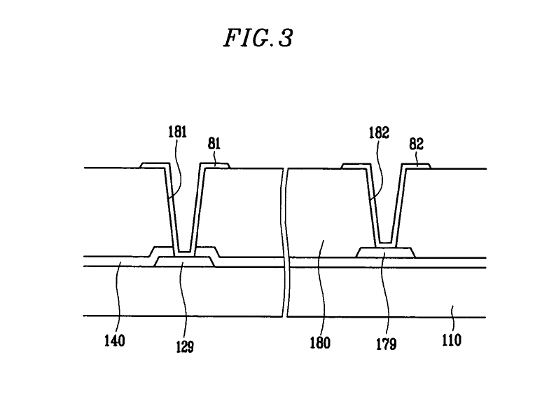

FIG. 1 is a top plan view layout of an exemplary embodiment of a liquid crystal display according to the present invention. FIG. 2 is a cross-sectional view of the exemplary embodiment of the liquid crystal display shown in FIG. 1 taken along line II-II. FIG. 3 is a cross-sectional view of the exemplary embodiment of the liquid crystal display shown in FIG. 1 taken along line III-III.

Referring to FIG. 2, an LCD according to an exemplary embodiment of the present invention includes a TFT array panel 100, a common electrode panel 200 opposing the TFT array panel 100, and a liquid crystal layer 3 disposed between the panels 100 and 200.

Referring to FIGS. 1 and 2, the TFT array panel 100 includes a plurality of gate lines 121 and a plurality of storage electrode lines 131 that are formed on an insulating substrate 110 such as transparent glass or plastic.

The gate lines 121 transmit gate signals and extend substantially in a transverse direction across the equivalent circuit diagram of FIG. 1. Each of the gate lines 121 includes a plurality of gate electrodes 124 projecting downward on the page as seen in FIG. 1 and an end portion 129 having a large surface area for contact with another layer or an external driving circuit. A gate driving circuit (not shown) for generating the gate signals may be mounted on a flexible printed circuit (“FPC”) film (not shown), which may be attached to the substrate 110, directly mounted on the substrate 110, or integrated onto the substrate 110. Alternatively, the gate lines 121 may extend to be connected to a driving circuit that may be integrated on the substrate 110.

Referring to FIG. 1, the storage electrode lines 131 are supplied with a predetermined voltage and each includes a stem extending substantially parallel to the gate lines 121 and a plurality of pairs of first and second storage electrodes 133a and 133b branching from the stem. Each of the storage electrode lines 131 is disposed between two adjacent gate lines 121 and the stem portion is proximate to one of the two adjacent gate lines 121. Each of the first and second storage electrodes 133a and 133b has a fixed end portion connected to the stem portion of the storage electrode line 131 and a free end portion disposed opposite thereto. The fixed end portion of the first storage electrode 133a has a large area and the free end portion thereof is bifurcated into a linear branch and a curved branch. However, this is but one exemplary embodiment, and the storage electrode lines 131 may have various shapes and arrangements.

The gate lines 121 and the storage electrode lines 131 may preferably include metals such as Al and Al alloy, Ag and Ag alloy, Cu and Cu alloy, Mo and Mo alloy, Cr, Ta, or Ti. Additionally, they may have a multi-layered structure including two conductive films (not shown) having different physical characteristics. One of the two films may be made of low resistivity metal including Al, Ag, and Cu for reducing signal delay or voltage drop. The other film may be made of material such as metal containing Mo, Cr, Ta, or Ti, which has preferred physical, chemical, and electrical contact characteristics with other materials such as indium tin oxide (ITO) or indium zinc oxide (IZO). Preferred examples of the combination of the two films are a lower Cr film and an upper Al (or Al alloy) film and a lower Al (or Al alloy) film and an upper Mo (or Mo alloy) film. However, this is but one exemplary embodiment, the gate lines 121 and the storage electrode lines 131 may be made of various metals or conductors.

Referring to FIG. 1, the lateral sides of the gate lines 121 and the storage electrode lines 131 are obliquely inclined relative to a surface of the substrate 110, and the inclination angle thereof ranges from about 30-80 degrees. The resulting cross-section of these elements is displayed in FIG. 2 where they exhibit a trapezoidal shape (FIG. 2 shows a gate electrode 124, which is a segment of the gate line 121). However, this is but one exemplary embodiment of the present invention.

As shown in FIG. 2 a gate-insulating layer 140 preferably made of silicon nitride (SiNx) or silicon oxide (SiOx) is formed on the gate lines 121 (FIG. 2 shows the gate-insulating layer 140 formed over a gate electrode 124, which is a segment of the gate line 121) and the storage electrode lines 131.

A plurality of semiconductor stripes 151 are formed on the gate-insulating layer 140 as shown in FIG. 2. The semiconductor stripes 151 are preferably made of hydrogenated amorphous silicon (a-Si) or polysilicon. As shown in FIG. 1, each of the semiconductor stripes 151 extends substantially in the longitudinal direction and includes a plurality of projections 154 branched out toward the gate electrodes 124.

Referring to FIG. 2, a plurality of ohmic contact stripes and islands 161 and 165 are formed on the semiconductor stripes 151. The ohmic contact stripes and islands 161 and 165 are preferably made of n+ hydrogenated a-Si heavily doped with n type impurity such as phosphorous or they may be made of silicide. Each of the ohmic contact stripes 161 includes a plurality of projections 163, and the projections 163 and the ohmic contact islands 165 are located in pairs on the projections 154 of the semiconductor stripes 151.

As shown in FIG. 2, the lateral sides of the semiconductor stripes 151 and the ohmic contacts 161 and 165 are obliquely inclined relative to the surface of the substrate 110, and the inclination angles thereof range from about 30-80 degrees. However, this is but one exemplary embodiment of the present invention.

A plurality of data lines 171 and drain electrodes 175 are formed on the ohmic contacts 161 and 165 and the gate-insulating layer 140.

Referring to FIG. 1, the data lines 171 transmit data signals and extend substantially in the longitudinal direction to intersect the gate lines 121. Each of the data lines 171 also intersects the storage electrode lines 131 and extends between adjacent pairs of storage electrodes 133a and 133b. Each data line 171 includes a plurality of source electrodes 173 projecting toward the gate electrodes 124 and also includes an end portion 179 having a large area for contact with another layer or an external driving circuit (not shown). A data driving circuit (not shown) for generating the data signals may be mounted on a FPC film (not shown), which may be attached to the substrate 110, directly mounted on the substrate 110, or integrated onto the substrate 110. Alternatively, the data lines 171 may extend to be connected to a driving circuit that may be integrated on the substrate 110. Other arrangements of the data driving circuit would be within the scope of these embodiments.

The drain electrodes 175 are separated from the data lines 171 and disposed opposite the source electrodes 173 with respect to the gate electrodes 124 as shown in FIG. 1.

Referring to FIG. 2 a gate electrode 124, a source electrode 173, and a drain electrode 175 along with a projection 154 of a semiconductor stripe 151 form a TFT. This TFT includes a channel formed above the gate electrode 124. This channel is disposed between the source electrode 173 and the ohmic contact stripe projections 163 on one side and the drain electrode 175 and the ohmic contact islands 165 on the other side.

The data lines 171 and the drain electrodes 175 may preferably be made of refractory metal such as Cr, Mo, Ta, Ti, or alloys thereof. However, they may also have a multilayered structure including a refractory metal film (not shown) and a low resistivity film (not shown). Examples of the multi-layered structure are a double-layered structure including a lower Cr/Mo (or Cr/Mo alloy) film and an upper Al (or Al alloy) film and a triple-layered structure of a lower Mo (or Mo alloy) film, an intermediate Al (or Al alloy) film, and an upper Mo (or Mo alloy) film. However, this is but one exemplary embodiment of the present invention, and the data lines 171 and the drain electrodes 175 may be made of various metals or conductors.

The data lines 171 and the drain electrodes 175 have obliquely inclined edge profiles, and the inclination angles thereof range from about 30 degrees to about 80 degrees.

As shown in FIG. 2 a passivation layer 180 is formed on the data lines 171, the drain electrodes 175, and the exposed portions of the semiconductor stripes 151. The passivation layer 180 may be made of an inorganic or organic insulator and may have a flat upper surface. Examples of the inorganic insulator include silicon nitride and silicon oxide. The organic insulator may have photosensitivity and dielectric constant less than about 4.0. The passivation layer 180 may include a lower film of an inorganic insulator and an upper film of an organic insulator. Such a combination provides the excellent insulating characteristics of the organic insulator while preventing the exposed portions of the semiconductor stripes 151 from being damaged by the organic insulator.

As shown in FIG. 1, the passivation layer 180 and the gate-insulating layer 140 have a plurality of contact holes 183a, which expose portions of the storage electrode lines 131 near the fixed end portions of the storage electrodes 133a. The passivation layer 180 and the gate-insulating layer 140 also have a plurality of contact holes 183b, which expose the linear branches of the free end portions of the first storage electrodes 133a.

As shown in FIGS. 1 and 2, the passivation layer 180 has a plurality of contact holes 185 exposing the drain electrodes 175.

As shown in FIGS. 1 and 3, the passivation layer 180 and the gate-insulating layer 140 have a plurality of contact holes 181 exposing the end portions 129 of the gate lines 121. The passivation layer 180 also has a plurality of contact holes 182 exposing end portions 179 of the data lines 171.

As shown in FIG. 1, a plurality of pixel electrodes 191, a plurality of overpasses 83, and a plurality of contact assistants 81 and 82 are formed on the passivation layer 180. They may be made of transparent conductors such as ITO or IZO or reflective conductors such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175. Once supplied with the data voltages, the pixel electrodes 191 generate electric fields in cooperation with a common electrode 270. The common electrode 270 is part of the common electrode panel 200 (to be described below) and is supplied with a common voltage. The electric fields generated between the pixel electrodes 191 and the common electrode 270 determine the orientations of liquid crystal molecules of the liquid crystal layer 3 disposed between the two electrodes 191 and 270. The pixel electrode 191 and the common electrode 270 form a capacitor referred to as a “liquid crystal capacitor,” which stores applied voltages after the TFT turns off.

As illustrated in FIG. 1, a pixel electrode 191 overlaps a storage electrode line 131 including storage electrodes 133a and 133b. The pixel electrode 191, a drain electrode 175 electrically connected thereto, and the storage electrode line 131 form an additional capacitor referred to as a “storage capacitor,” which enhances the voltage storing capacity of the liquid crystal capacitor.

The overpasses 83 cross over the gate lines 121 and are connected to the exposed portions of the storage electrode lines 131 through the contact hole 183a. The overpasses are further connected to the exposed linear branches of the free end portions of the first storage electrodes 133a through the contact holes 183b. The two contact holes 183a and 183b are disposed opposite each other with respect to the gate lines 121. The storage electrode lines 131 including the storage electrodes 133a and 133b along with the overpasses 83 can be used for repairing defects in the gate lines 121, the data lines 171, or the TFTs.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

Referring to FIG. 2, a light-blocking member 220, referred to as a black matrix, prevents light leakage and is formed on an insulating substrate 210. The light-blocking member 220 has a plurality of openings above the pixel electrodes 191 and the openings may have substantially the same planar shape as the pixel electrodes 191. Otherwise, the light-blocking member 220 may include a plurality of rectilinear portions facing the data lines 171 on the TFT array panel 100 and a plurality of widened portions facing the TFTs on the TFT array panel 100.

A plurality of color filters 230 are also formed on the substrate 210 and they are disposed substantially in the areas enclosed by the light-blocking member 220. The color filters 230 may extend substantially in the longitudinal direction along the pixel electrodes 191. Each of the color filters 230 may represent one of the primary colors such as red, green and blue.

A common electrode 270 is formed on the color filters 230. The common electrode 270 may be made of a transparent conductive material such as ITO and IZO.

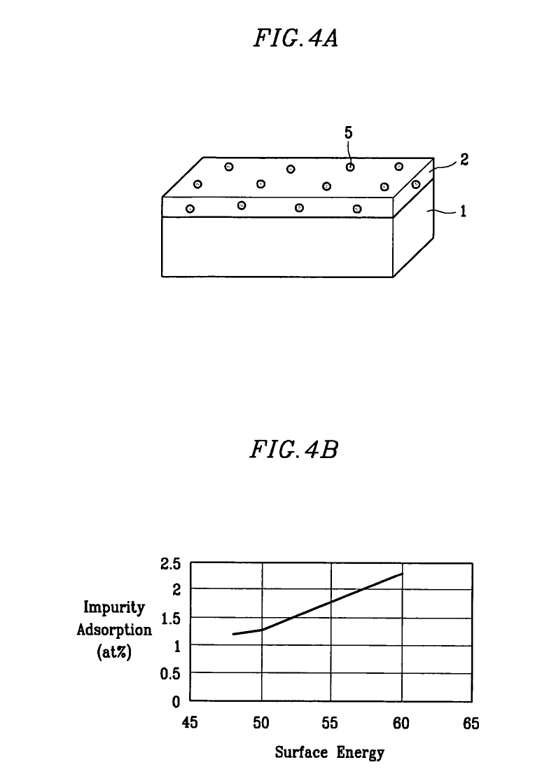

Alignment layers 11 and 21 are respectively coated on the surfaces of the panels 100 and 200 that are immediately adjacent to the liquid crystal 3. The alignment layers 11 and 21 may be made of insulating material such as polyimide and may be homogeneous. The surface energy of the alignment layers 11 and 21 may range from about 50 dyn/cm to about 60 dyn/cm. The alignment layers are discussed in more fully below with reference to FIGS. 4A, 4B, 5, 6, 7 and 8.

A pair of polarizers (not shown) may be provided on the surfaces of the panels 100 and 200 so that their polarization axes may be crossed or parallel. One of the polarizers may be omitted when the LCD is a reflective LCD.

The liquid crystal layer 3 may have positive dielectric anisotropy and it may be subjected to a horizontal alignment so that the liquid crystal molecules in the liquid crystal layer 3 are aligned with their long axes substantially parallel to the surfaces of the panels 100 and 200 in absence of an electric field.

FIG. 4A schematically shows a liquid crystal panel and an alignment layer disposed thereon according to an exemplary embodiment of the present invention.

As described above, the liquid crystal layer 3 (shown in FIG. 2) may contain ion impurities. To reduce the effects of the ion impurities the alignment layer 2 in this embodiment has a high surface energy for uniformly adsorbing ion impurity from the liquid crystal layer 3. Referring to FIG. 4A, the entire surface of the alignment layer 2, which has a high surface energy and is disposed on a display panel 1, uniformly adsorbs ion impurity 5. In this manner the ion impurity contained in the liquid crystal layer can be considerably reduced. The alignment layer 2 may be any of the alignment layers 11 and 12, and the panel 1 may be any of the TFT array panel 100 and the common electrode panel 200 without the alignment layers 11 and 21.

The surface energy of the alignment layer 2 can be quantified by measuring a contact angle between an alignment layer and a drop of water on a surface of the alignment layer. The surface energy is then obtained by inputting the measurement into a theoretical formula.

FIG. 4B is a graph showing the relation between the surface energy and the adsorption of the ion impurities.

As shown in the graph, the impurity adsorption increases as the surface energy increases, and the impurity adsorption greatly increases as the surface energy exceeds about 50 dyn/cm. However, when the surface energy is increased beyond a certain level, the surface of the alignment layer may become unstable such that even a slight change in processing conditions, such as temperature, may cause spots.

Accordingly, it is preferable that the surface energy of the alignment layer 2 ranges from about 50 dyn/cm to about 60 dyn/cm in consideration of the impurity adsorption and spot occurrence.

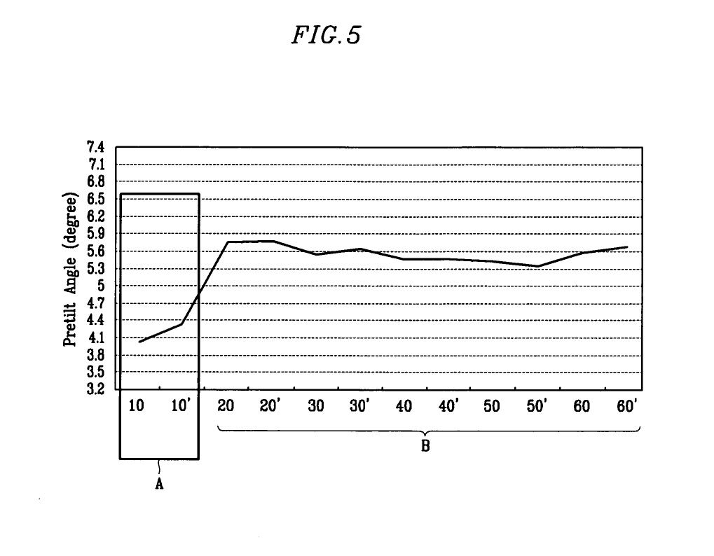

FIG. 5 is a graph showing the occurrence of the linear afterimage according to the pretilt angle. An exemplary embodiment of the present invention controls the pretilt angle to improve linear afterimage.

In this graph, the abscissa represents six different kinds of liquid crystal materials (10, 20, 30, 40, 50 and 60) and those (10′, 20′, 30′, 40′, 50′, 60′) obtained by three-times filtering those same liquid crystal materials to remove impurity to some degree, and the ordinate represents the pretilt angle. In addition, the region labeled “A” denotes the existence of the linear afterimage under the application of an electric field, and the region labeled “B” denotes the non-existence of the linear afterimage.

Referring to the curve, the pretilt angles for different liquid crystal materials differ, and the linear afterimage occurs when the pretilt angle is lower than about 5 degrees (as shown by materials 10 and 10′ in box A). That is, the curve shows that the pretilt angle affects the linear afterimage. It is presumed that the reason why a large pretilt angle improves the linear afterimage is that the liquid crystal molecules having a large pretilt angle obstruct the movement of the ion impurities in the liquid crystal layer.

However, a pretilt angle larger than about 10 degrees may degrade alignment uniformity, response time and brightness. Therefore, the pretilt angle is preferably controlled to be from about 5 degrees to about 10 degrees.

The pretilt angle of liquid crystal molecules can be controlled by adjusting a microstructure of an alignment layer.

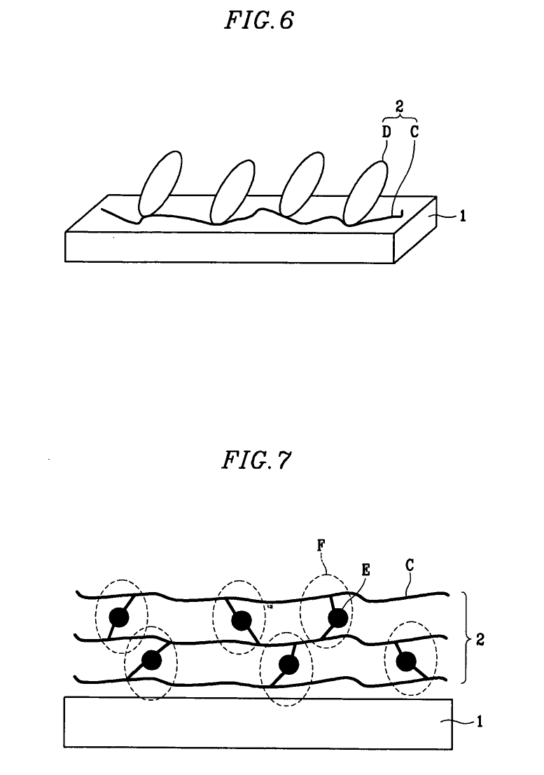

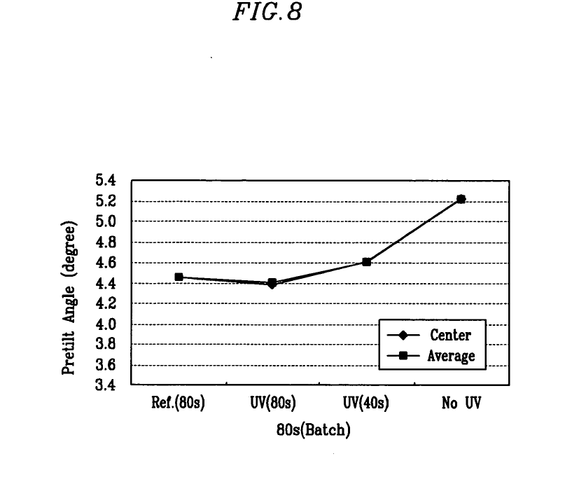

FIGS. 6 and 7 are schematic diagrams showing exemplary embodiments of structures of an alignment layer according to the present invention.

Referring to FIG. 6, an alignment layer 2 is a polymer including a main chain C and side chains D. The main chain C extends along a surface of a display panel 1, and the side chains are attached to the main chain C at several places and stand up toward the liquid crystal layer 3 (shown in FIG. 2). According to one exemplary embodiment the side chains D may be a structure including an aromatic group. Since the aromatic group is planar, a rubbing process may raise the side chains D to make an angle with the display panel 1. Accordingly, controlling the tilt angle of the aromatic group can control the pretilt angle of the liquid crystal molecules.

Referring to FIG. 7, the alignment layer 11 may further include crosslinking agents E. The crosslinking agents E may combine main chains C of adjacent polymers during the post-baking of the alignment layer 2 (the crosslinking action is highlighted in region F). The crosslinking agents E may raise the hardness and the durability of the alignment layer 2. In addition, the pretilt angle of the liquid crystal molecules can be controlled by adjusting the average roughness of the alignment layer 2. The average roughness of the alignment layer is defined as an average deviation of peaks and valleys that are measured from an average height line in cross-sections of the alignment layer.

The average roughness of the alignment layer according to an exemplary embodiment of the present invention is equal to or less than about 8 nm.

Since an alignment layer is much thinner than an underlying layer, the average roughness of the alignment layer is substantially equal to the average roughness of the adjoining layer. Therefore, controlling the average roughness of the adjoining layer can control the average roughness of the alignment layer.

In the common electrode panel 200 shown in FIG. 2, the average roughness of the alignment layer 21 is significantly affected by the adjoining color filters 230.

Varying process conditions can control the average roughness of the color filters 230. The color filters 230 may be formed by coating a photosensitive organic film, exposing the organic film to light with a predetermined pattern, developing the organic film, baking the organic film, and performing surface treatment with ultraviolet radiation (UV) for about 80 seconds. Among the above-described process steps, the surface treatment step produces the most affect on the average roughness of the color filters 230.

Table 1 shows the average roughness of red, green, and blue color filters with and without the exposure to UV.

TABLE 1

| | | UV Exposure Time (second) | | |
|---|---|---|---|---|
| | | 0 | 40 | 80 |
| Average | Red Filter | 6.57 | 11.43 | 13.98 |
| Roughness | Green Filter | 7.85 | 9.55 | 10.41 |
| (nm) | Blue Filter | 3.61 | 5.95 | 6.47 |

This shows that the average roughness increases as the UV exposure time increases and the omission of the UV exposure causes the average roughness to fall below about 8 nm.

FIG. 8 is a graph showing the pretilt angle as a function of UV exposure time.

Referring to FIG. 8, the pretilt angle is greater than about 5 degrees without the UV exposure of the color filters.

By controlling the average roughness of the alignment layer, the pretilt angle of the liquid crystals can be controlled to reduce the linear afterimage. In addition, the alignment layer can be modified to adsorb ion impurities from the liquid crystal layer also significantly reducing the linear afterimage.

The alignment layer according to the present invention can be applied to a liquid crystal display including pixel electrodes and common electrodes disposed on the same panel.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A liquid crystal display comprising:
a first panel;
a second panel facing the first panel;
a pair of electric-field generating electrodes formed on at least one of the first panel and the second panel;
an alignment layer formed on at least one of the electric-field generating electrodes and having an average roughness equal to or less than about 8 nanometers and a pretilt angle equal to or greater than about five degrees; and
a liquid crystal layer disposed between the first panel and the second panel.

2. The liquid crystal display of claim 1, wherein the pretilt angle of the alignment layer is substantially equal to or lower than about ten degrees.

3. The liquid crystal display of claim 1, wherein the alignment layer has a surface energy substantially equal to or greater than about 50 dyn/cm.

4. The liquid crystal display of claim 3, wherein the surface energy of the alignment layer is substantially equal to or less than about 60 dyn/cm.

5. The liquid crystal display of claim 1, wherein the alignment layer comprises polymers, and each polymer comprises a main chain and a side chain, the main chain extending along a surface of the first panel and the side chain coupled to an intermediate position of the main chain and comprising a structure controlling the tilt of the liquid crystal molecules.

6. The liquid crystal display of claim 5, wherein the structure controlling the tilt of the liquid crystal molecules comprises an aromatic group of polymers.

7. The liquid crystal display of claim 6, wherein the alignment layer is rubbed, and the pretilt angle of liquid crystal molecules is substantially equal to the angle that the side chain stands at due to the rubbing.

8. The liquid crystal display of claim 5, wherein the alignment layer further comprises a crosslinking agent combining the main chains of the polymers.

9. The liquid crystal display of claim 1, wherein the alignment layer comprises polyimide compounds.

10. The liquid crystal display of claim 1, further comprising a color filter disposed adjacent at least one of the electric-field generating electrodes and having an average roughness equal to or less than about eight nanometers.

11. The liquid crystal display of claim 1, further comprising:
a gate line disposed on one of the first panel and the second panel;
a data line intersecting the gate line; and
a thin film transistor electrically coupled to the gate line, the data line, and the electric-field generating electrode.

12. A method of making a liquid crystal display comprising:
forming a first panel;
forming a second panel;
forming a first electric-field generating electrode on at least one of the first panel and the second panel;
forming a second electric-field generating electrode on at least one of the first panel and the second panel;
forming an alignment layer on at least one of the first electric-field generating electrode and the second electric-field generating electrode and having an average roughness equal to or less than about 8 nanometers and pretilt angle equal to or greater than about five degrees relative to a surface of the alignment layer; and
forming a liquid crystal layer disposed between the first panel and the second panel.
